(19) United States
(12) Patent Application Publication
(10) Pub. No.: US 2024/0301682 A1
(43) Pub. Date: Sep. 12, 2024

(54) Thermal Insulation Board

(71) Applicant: COLDINS OY, Lahti (FI)

(72) Inventor: Juha HELIN, Muurame (FI)

(21) Appl. No.: 18/550,380

(22) PCT Filed: Mar. 19, 2022
(86) PCT No.: PCT/FI2022/050179

§ 371 Date: Sep. 13, 2023

(30) Foreign Application Priority Data
Mar. 28, 2021 (FI) 20217055

(51) Int. Cl. E04B 1/80; E04B 1/74

(52) U.S. Cl. CPC E04B 1/806; E04B 2001/748

(57) ABSTRACT

A thermal insulation board (100) for use in thermal insulation of a structure, comprising a first face (100A) and a second face (100B) opposite to the first face (100A), the insulation board having a thickness of thermal insulation material between the first face and the second face defining the thermal insulation direction of the board (100). The thermal insulation board (100) comprises one or more gas channels (102, 104, 106) formed to the insulation material and extending between the first face (100A) and the second face (100B), and that the one or more gas channels are arranged at least partly to an angled orientation such that the first end (102A) of the channel (102) residing closer to the first face (100A) is vertically lower, in a usage position of the thermal insulation board (100), than the second end (102B) of the gas channel (102).

### FIELD

The invention relates to a thermal insulation board.

### BACKGROUND

Heat insulation of buildings and premises, and other structures such as boilers, for instance, can be carried out by using thermal insulation boards. Such boards may operate in both ways, on the one hand by maintaining the heat inside the structure, or on the other hand by preventing heat to enter the interior of the structure.

Thermal insulation may, however, have the disadvantage that temperature balancing between the interior and exterior of the structure is deteriorated.

It is thus evident that there is a need for an improved thermal insulation board.

### BRIEF DESCRIPTION

It is the objective of the invention to at least partly alleviate the abovementioned problem. This is achieved with the invention that is the scope of the independent claims. Preferred embodiments have been disclosed in the dependent claims.

The embodiments of the invention provide the significant advantage of improved thermal balancing on both sides of the thermal insulation board.

### DRAWINGS

The invention and its preferred embodiments are shown in the accompanying drawings, where

FIG. 1A shows an embodiment of a thermal insulation board according to the invention from a first side face;

FIG. 1B shows the insulation board of FIG. 1A from the direction of an end face;

FIG. 1C shows the insulation board of FIG. 1A from the direction of the second side face;

FIG. 2A shows a perspective view of an insulation board;

FIG. 2B illustrates the interior of the insulation board of FIG. 2A;

FIG. 3 highlights a covering member applied to the embodiment of FIG. 2A;

FIG. 4 illustrates another embodiment of a thermal insulation board; and

FIG. 5 shows an embodiment of a method.

### DETAILED DESCRIPTION

The embodiments relate to a new thermal insulation board or sheet or plate or structure for use in thermal insulation and thermal balancing of a structure. The main application areas of the insulation board according to the embodiments are warm/hot environmental conditions, such as in Southern Europe or Middle East, for instance. Preferred application areas include those between −45 to 45 latitude degrees, that is less than 45 degrees from the equator. The purpose of the insulation board is to prevent, or at least significantly reduce, heat entry into the building during daytime when the outside temperature is high. During the night-time, when the temperature is lower, the insulation board according to the embodiments is arranged to convey heat from the inside of the building to the outside.

The thermal insulation/balancing board according to the embodiments may be manufactured from known insulation materials such as polyurethane, polystyrene, cellulose, polyethylene or some other known thermal insulation material. The phase of the thermal insulation material is thus principally solid. It is understood, however, that among the solid insulation material described above, there may also be some air. The material used for manufacturing the thermal insulation/balancing board is generally opaque or non-transparent. This means that light or heat radiation cannot proceed through the thermal insulation material, and also not through the thermal balancing board at least when entering the board from the perpendicular direction. This has the advantage that the solar radiation cannot directly pass the insulation board thus improving its insulation characteristics.

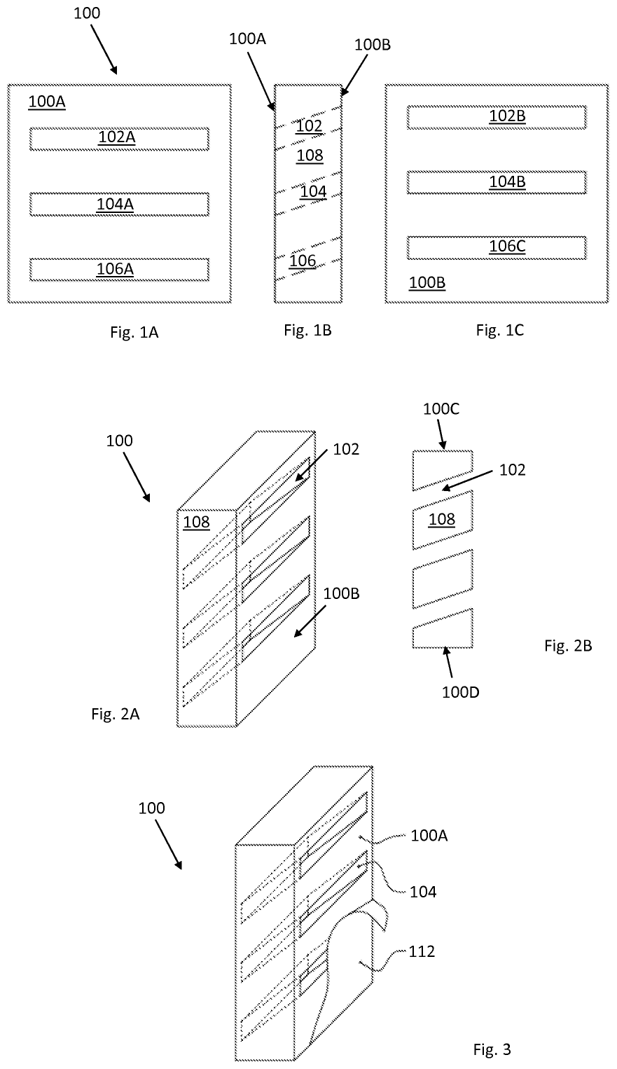

FIGS. 1A to 1C show one embodiment of such a thermal insulation board. The insulation board is shown in its principal mounting orientation being the vertical orientation. In FIG. 1A, the board is shown from a first face, in FIG. 1B from side, and in FIG. 1C from a second face. In an exemplary embodiment, the insulation board is used in insulation of a building wall, and the first face 100A may be arranged towards an interior of the building, and the second face 100B towards an exterior of the building. The thickness of the insulation board 100 may substantially equal to the thickness of the wall of the building whereby the thickness of the board defines the thermal insulation direction of the board.

In the embodiments, gas channels 102, 104 and 106 have been formed into the insulation board. The channels may be formed to the board during the molding, shaping or making process or the channels may be formed by drilling or some other similar mechanical working method after the insulation board has been established or during board manufacturing. The thermal insulation/balancing board comprises thus solid thermal insulation material between the first face 100A and second face 100B in other areas of the board except in the channels which are empty/void gas channels. Solid insulation material is known to have the best insulation characteristics because the heat convection through the material is very slow compared to gaseous insulation where the convection through the gas happens relatively quickly.

In some embodiments, the height of the channels is between 5 to 50 millimeters but may also exceed that in the case of thick insulation boards. Preferably the height is between 15 to 35 millimeters. The height of the channel refers here, in the case of a rectangular channel as shown in FIG. 1A, to the distance of the upper end and lower end of the channel in the vertical direction. In case of a circular channel, the height of the channel would refer accordingly to the diameter of the channel. When tying the height of the channel to the thickness of the insulation board, the tests have indicated that the most optimal ratio between these is between 25 to 45 percent. That is, optimally the vertical height of the channel is between 25 to 45 percent of the thickness of the board. When the ratio between the channel height and thickness goes below 25 percent, the thermal balancing characteristics of the structure deteriorate significantly, and when the ratio is over 45 percent, the insulation characteristics of the board become significantly compromised.

The distance between the channels may vary between 1 to 99-100% of the thickness of the insulation board. When referring to the height of the channel, optimally the distance between the channels is between 0.1 to 3 times the height of a single channel. The thickness of the insulation boards typically used in construction business is between 30 to 600 millimeters. A thick insulation board may also be layered from a plurality of insulation board layers, in which case the thickness of a single layer can be also under 30 millimeters.

In the embodiments, the gas channels extend at least substantially from the first face 100A to the second face 100B. In one embodiment, the channels extend completely from the first face to the second phase such that there is a channel opening 102A and 102B on both faces. In another embodiment, at least one of the channels may extend substantially to the face of the board but does not have an opening on the face. In such an embodiment, the channel may extend, for instance, a few millimeters from the first face and/or the second face and there may be insulation material between the channel end and the face of the board.

FIG. 1A shows first ends 102A, 104A and 106A of three gas channels, such as air channels. The ends of the gas channels on the first face 100A may have a rectangular shape. Even though the FIGS. 1A to 1C, for instance, show the channels as having a rectangular shape, the embodiments are not limited thereto. That is, the channels and channel ends may take some other forms, and have a round, oval, hexagonal, triangular, or some other shape or cross-section.

FIG. 1B illustrates the gas channels from a side, that is seen from a direction where the thickness of the board is visible. The thickness is here defined by the distance of the first face 100A and the second face 100B. In the embodiment of FIG. 1B, the gas channel is arranged to an angled or oblique or tilted or skewed orientation such the first end 102A of the channel 102 on the first face 100A resides vertically lower, in the normal usage position, than the second end 102B of the channel. In an embodiment, the tilting of the channel is between 10 to 80 degrees, more preferably being between 15 to 75 degrees, most preferably between 40 to 60 degrees compared to the horizontal level which correspond to the orientation of the top surface 100C and the bottom surface 100D of the board. By a 40 to 60 degree tilting, the heat conduction from the inside to the outside during night-time has been found to be most effective.

FIG. 1B shows the channels as having a constant height along the channel and also at the ends 102A and 102B of the channels. In another embodiment, the channel may have a Z-shape such that the ends of the channels have a larger cross-section than the portions of the channel that reside between the ends. In this way the interaction area of the gas interior of the channel and exterior of the channel at the surface of the insulation board can be increased. Also the distances between the channels inside the insulation board can accordingly be increased whereby the insulation properties of the board are enhanced while the heat conduction properties are still maintained. In still a further embodiment, the channels are not straight but can be curved. At least one of the channel ends 102A and/or 102B is closed so that gas cannot flow through that end of the channel. This is highlighted by FIG. 3, which shows a foil 112, which may be attached to the respective face such as face 100A, for instance. Preferably, the foil may cover the entire face but may also cover a smaller portion of the face. In some embodiments, both the first face and the second face are covered by respective covers, where each foil may be made of cardboard, aluminium or plastic. The foil or other cover is preferably opaque preventing direct radiation to enter the channels.

The embodiment of FIGS. 1A to 1C is applicable in providing thermal insulation to a building, such as a residential house or an industrial plant. In warm or hot environment, the insulating board 100 provides the significant advantage that during day-time the insulating board prevents heated air to enter the building. Firstly so due to the insulation material itself but secondly also due to the angled gas channels whereby the hot air tends to stay vertically higher and does not flow towards the lower end 102A of the channel 102.

FIGS. 2A and 2B show other views of the insulation board of FIGS. 1A to 1C. In FIG. 2A, the channels 102 are illustrates by dashed lines and it can be seen that they rise towards the second face 100B. FIG. 2B shows a cross-section of FIG. 2A showing the channel 102, and insulating material 108 between the channels.

During night-time when the temperature declines, the channels operate in conveying heat from the interior of the building to the exterior of the building. That is, heat generally moves upwards, whereby the heated air travels to the upper end 102B of the channel 102 thereby releasing heat to the cooled outside air.

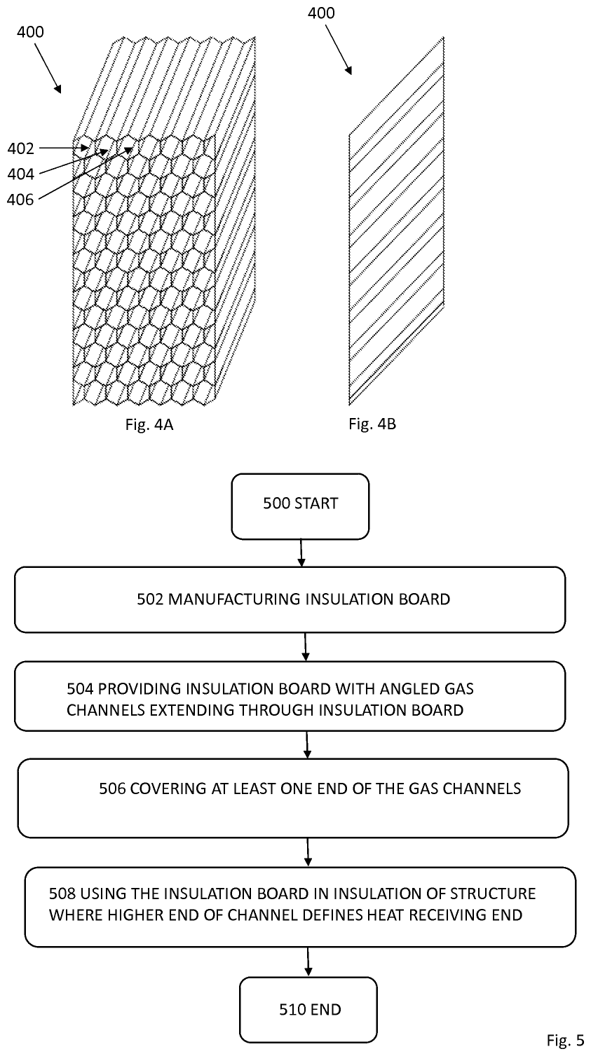

FIGS. 4A and 4B show another embodiment of a thermal insulation board 400, which in some construction may be manufactured of polyethylene. In this embodiment, the board is constructed as a honeycomb structure such that the channels 402, 404 and 406 are formed as hexagons. The channels are immediately adjacent to each other in contrast to the embodiment of FIG. 2B where there is a certain layer of insulating material 108 between the channels. Also in the embodiment of FIG. 4, the channels 402, 404 and 406 are arranged to an angled orientation with respect to the horizontal and vertical orientations thereby allowing the physical phenomena of heat transfer to a higher location to take place. The embodiment of FIGS. 4A and 4B is not limited to that the channels have a hexagonal cross-section but alternatively the channels may be pipes having e.g. a round cross-section.

FIG. 5 shows an embodiment of the method. In step 502, the insulation board is manufactured by molding, shaping or cutting, for instance. During the manufacturing phase 502, or thereafter, in step 504 the insulation board is provided with angled gas channels. The gas channels are thus non-parallel and non-perpendicular to the surface level of the first face and the second face, whereby the mentioned angle is between 0 to 90 degrees. The gas channels are preferably for housing air but alternatively some other gas may be used. The gas channels may be formed either during the initial molding phase, or they can be formed e.g. by drilling afterwards.

In 506, at least one end of the gas channels is covered. In one embodiment, the covering may be already part of the initial molding phase. That is, the channels may be formed such that they have an opening at one end of the channel, but at the other end of the channel there is a layer of insulating material. The layer may be very thin, between 0.1 to 10 millimeters, for instance, such that it prevents air flow but allows heat transfer through the thin insulation layer. In another embodiment, a foil layer may be attached to the side face of the board having the channel ends. The foil may be a metal or plastic foil, for instance, and may be attached to the face by gluing, for instance.

In 508, the thermal insulation board is applied in thermal insulation of structure such as a building or a water boiler, for instance. The board is arranged to a position where the vertically higher ends of the channels face towards the space or structure where the heat is desired to be directed. In the case of the water boiler, for instance, the higher end of the channel is closer to the surface of the water boiler as it is desired that the solar heat flows along the channel to the surface of the boiler. Correspondingly, in an exemplary case of the building cooling, the higher ends of the channel are arranged closer to the exterior of the building. Thereby the channel prevents the heat to enter the building during day-time and allows heat to flow out of the building during night when the building exterior is cooler than the inside of the building.

In an aspect, there is provided a method by manufacturing a thermal insulation board having angled channels at least essentially through the insulation board, which channels are closed from at least one end of the channel, and using the insulation board in thermal insulation of a structure such that when it is desired to remove heat from the structure, an end of the channel that resides further away from the interior of the structure is higher than the other end of the channel, and when it desired to conduct heat towards the structure, an end of the channel that resides further away from the interior of the structure is vertically lower than the other end of the channel.

It is clear that when the technology develops the inventive idea can be implemented in various ways. The invention and its embodiments are thus not limited to disclosed embodiments but can vary within the appended claims.

1. A thermal insulation board for use in thermal insulation of a structure, comprising a first face and a second face opposite to the first face, the insulation board having a thickness of thermal insulation material between the first face and the second face defining the thermal insulation direction of the board, wherein the insulation board comprises one or more gas channels formed to the insulation material and extending between the first face and the second face, each gas channel having a first end and a second end, and at least one of the first end and the second end is closed preventing gas flow via said channel end, and that the one or more gas channels are arranged at least partly to an angled orientation such that the first end of the channel residing closer to the first face is vertically lower, in a usage position of the thermal insulation board, than the second end of the gas channel residing closer to the second face of the insulation board.

2. A thermal insulation board according to claim 1, wherein the one or more gas channels extend at least substantially from the first face to the second face.

3. A thermal insulation board according to claim 1, wherein the one or more gas channels extend to the first face and/or to the second face such that the channel has an opening on the respective face.

4. A thermal insulation board according to claim 1, wherein the gas channel is arranged to rise in vertical direction in constant manner from the first face to the second face.

5. A thermal insulation board according to claim 1, wherein the one or more gas channels have a rectangular or round cross-section in a longitudinal direction of the channel.

6. A thermal insulation board according to claim 1, wherein the one or more gas channels extend to both the first face and the second face, and each gas channel is closed from both ends of the gas channel such that the gas channel forms a closed space.

7. A thermal insulation board according to claim 1, wherein the insulation board comprises a foil attached to at one of the first face and the second face, which foil is arranged to cover an end of the channel to prevent gas flow through the end of the channel.

8. A thermal insulation board according to claim 1, wherein the foil is arranged to cover at least substantially the first face or the second face.

9. A thermal insulation board according to claim 1, wherein the insulation board is arranged as a honeycomb structure having a plurality of adjacent and parallel hexagonal or round channels, which channels are arranged to an angled orientation to a mounting orientation of the thermal insulation board.

10. A thermal insulation board according to claim 1, wherein the insulation board comprises a plurality of adjacent and mutually aligned channels.

11. A thermal insulation board according to claim 1, wherein the channels have a larger cross-section at the end of the channel than in a portion between the ends of the channel.

12. A thermal insulation board according to claim 1, wherein the gas channel is arranged to an angle from 15 to 75 degrees compared to a horizontal level.

13. A thermal insulation board according to claim 1, wherein the channel has a height, and the height of the channel is between 25 to 45 percent of the thickness of the thermal insulation board.

14. A thermal insulation board according to claim 1, wherein the phase of the thermal insulation material is generally solid.

15. (canceled)

16. A thermal insulation board according to claim 1, wherein the thermal insulation material is opaque and/or the foil covering the thermal insulation board are opaque.

17. A thermal insulation board according to claim 1, wherein the thickness of insulation material and orientation of the gas channels are configured to prevent heat entry to inside of a building during daytime when outside temperature is high, and the orientation of the gas channels are configured to convey heat from the inside of the building to the outside of the building during night-time when the outside temperature is lower than the inside temperature.

18. A method of manufacturing the thermal insulation board of claim 1 of an insulation material, wherein the method comprises forming angled gas channels to the insulation material at least essentially through the insulation board, which channels are closed from at least one end of the channel.

19. A method of using the insulation board of claim 1 in thermal insulation of a building by positioning lower ends of the gas channels facing inside of the building such that during daytime the insulation board prevents heat ingress to the inside of the building, and during night-time when it is desired to remove heat from the structure, the gas channels convey heat from the inside of the building towards the exterior of the building.

20. A thermal insulation board according to claim 2, wherein the thermal insulation board is opaque.

21. A thermal insulation board according to claim 20, wherein the structure is a building, and wherein the first face is configured to be arranged towards an interior of the building, and the second face is configured to be arranged towards an exterior of the building.
